(19) United States
(12) Patent Application Publication
(10) Pub. No.: US 2016/0228830 A1
(43) Pub. Date: Aug. 11, 2016

(54) WINE OXYGENATION DEVICE

(71) Applicant: LINDE AKTIENGESELLSCHAFT, Munich (DE)

(72) Inventor: Thomas Bickford Holbeche, Church Crookham (GB)

(21) Appl. No.: 15/024,046

(22) PCT Filed: Oct. 15, 2014
(86) PCT No.: PCT/GB2014/000414

§ 371 Date: Mar. 23, 2016

(30) Foreign Application Priority Data
Oct. 15, 2013 (GB) GB1318205.0

(51) Int. Cl. B01F 3/04; C12G 1/00

(52) U.S. Cl. CPC B01F 3/04801; C12G 1/00; B01F 3/04269; B01F 2003/04879; B01F 2003/04404; B01F 2215/0072

(57) ABSTRACT

A method and apparatus for adding oxygen gas into wine in a wine bottle from a compressed gas cylinder. The device includes a body for receiving a pressurised gas cylinder containing at least 20% oxygen by volume, a tube with a first end connected to the body and a second end connected to a membrane. The membrane is made up of a plurality of hollow fibres and is insertable through the neck of the wine bottle so that, in use, oxygen gas diffuses via the membrane into the wine.

The present invention relates to a device for oxygenating wine.

Adding controlled amounts oxygen to wine, or aerating the wine, is known to improve its taste. Typically, wine is aerated before use via a decanter or carafe. In a recent development wine can also be aerated using a venturi type system whereby the wine is poured from the bottle into an intermediary vessel above the wine glass, and the wine then aerated via the venturi effect as it passes from the intermediary vessel to the wine glass. Both of these aerating methods however are limited in terms of the rate of which air can be introduced into the wine.

According to the present invention there is provided a wine aerating device according to claim 1.

A device which allows the combination of a pressurised oxygen containing gas (allowing for a large amount of gas to be delivered) and the gas diffusing membrane (allowing for a controlled release of this gas) together allows a relatively high flow rate of oxygen gas to be diffused into the wine in a controlled manner to avoid excessive foaming. The diffusive effect of the membrane can produce small bubbles which allow the oxygen gas to be diffused efficiently into, and also quickly react, with the wine.

By having the membrane in fibre form, for a given volume of membrane, the membrane can have a large surface area for diffusing oxygen gas into the wine. By increasing this surface area to volume ratio of the membrane, the speed in which the wine can be aerated is also increased. Typically, there may be between two and one hundred hollow fibres in the membrane. Alternatively, the membrane may comprise a single wound fibre which may either be wound on a mandrel, or which may be freely wound and self supporting.

The tube may pass from the body beyond the membrane to a manifold from which the membrane extends back towards the body. With this configuration, the direction of the gas flow between the cylinder and the membrane in the tube must necessarily involve a change in direction. This change of direction can be used to throttle the pressure of the gas inside the tube to prevent the membrane from being damaged by gas which is at high a pressure. It also provides enhanced diffusion of gas across the membrane since it allows the gas from the cylinder to be better distributed across the total area of the membrane.

The membrane may be elongate in the direction of insertion to provide the membrane with a larger surface area/width ratio so to increase the amount of aeration of the wine in the bottle.

The device may comprise a pressure limiting valve for lowering the pressure of the gas from the cylinder to a predetermined pressure before the gas reaches the membrane. In this case, the valve may comprise a valve seat and a valve head, wherein the predetermined pressure is maintained by a spring means which controls the separation between the valve seat and the valve head. With the pressure limiting valve, the pressure of the gas passing through to the membrane can be better controlled.

The pressure inside the cylinder, when full, may be between 2 MPa and 30 MPa. Using a defined pressure range in the cylinder allows the aeration process to be carefully controlled.

When gas flows from the cylinder, the pressure of the gas at the membrane may be less than 50% of the pressure inside the cylinder. More preferably, the pressure at the membrane may be less than 25% of the pressure inside the cylinder. Even more preferably, the pressure at the membrane may be less than 10% of the pressure inside the cylinder. Still more preferably, the pressure at the membrane may be less than 4% of the pressure inside the cylinder. By increasing the pressure in the cylinder and having a large pressure drop, this allows the cylinder to be made smaller and more compact.

The pressure in the cylinder and the size of the tube and membrane may be such that the device can supply 3-10 mg O₂/l wine, measured at atmospheric conditions, to 75 cl of wine in less than 2 minutes.

The device may comprise a protective sheath, surrounding the membrane, and containing outlets which allow gas to pass therethrough. The protective sheath protects the membrane, which may be delicate, from damage by accidental contact with the side of the bottle or any other items which may damage it.

The membrane may in particular be a dense membrane. An advantage of this membrane type is that it does not have pores which can become clogged, and it does not leak, or “wet”, as other membrane types can do.

The membrane may additionally or alternatively comprise a microporous membrane. By using either a dense membrane and/or a microporous membrane, these membranes have been found to be more effective at producing bubbles with a small mean size.

The membrane may be made of a polymeric material to improve the amount of gas diffusing therethrough and reacting with the wine. An example material is polymethylpentene.

A portion of the membrane may be made from a hydrophilic material. This way, the device can be more easily cleaned after it has been immersed in wine.

The device may further comprise a mount for mounting the device on the neck of the wine bottle. This allows the membrane to be positioned towards the centre of the wine volume inside the bottle. In some embodiments, the mount may comprise a bung which is dimensioned to fit in the neck of the wine bottle. The mount may alternatively or additionally comprise a plurality of legs which are each dimensioned to extend down the outside surface of the neck of the wine bottle. It will be appreciated however that the mount may have any shape necessary to achieve the intended positioning effect.

The device may further comprise a piercing element for piercing a seal on the cylinder. With the piercing element, the device can be used with gas cylinders which are sealed by a crimped or welded diaphragm. With such cylinders, the piercing element, which may be in the form of a hollow tube, can pierce the diaphragm to allow gas to escape from the cylinder and into the device.

The body, the tube, and the membrane may be co-axial to provide an easily determinable centre of gravity for the device. This axis may extend through the neck of the wine bottle when the device is placed thereon. With this arrangement, when the device is placed on the bottle, the device's centre of gravity is more likely to act through the neck of the wine bottle, ensuring that the device is stable on the bottle.

To allow the membrane to pass readily into the wine bottle, the width of the membrane may be leas than 18 mm.

According to another aspect of the present invention, there is provided a method of adding oxygen containing gas to a volume of wine of 75 cl according to claim 20. Being able to aerate such quantities of wine in this time interval is clearly useful to the end consumer of wine, since they are readily able to aerate a wine bottle just before serving, much more quickly and effectively than with a decanter, carafe, or venturi type aerator.

In this method, the membrane may comprise any of the preferred features described above.

In this method, the wine may be contained in a wine bottle and the method may further include the step of inserting the membrane through the neck of the wine bottle.

It will also be appreciated that any form of pressurised gas source may be used. Indeed, the gas cylinder described above may be single use, replaceable or refillable. The device may be manufactured and distributed with or without a pressurised gas cylinder.

The invention also provides a kit comprising a device as set out above and a compressed gas cylinder containing at least 20% oxygen by volume when measured at atmospheric conditions.

The present invention will now be described with reference to the following Figures in which:

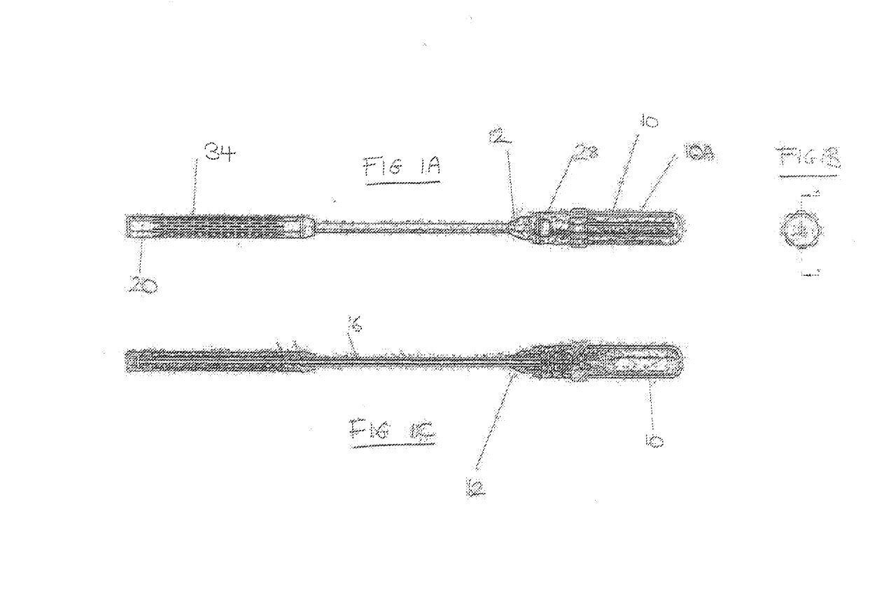

FIG. 1A shows a plan view of the aerator assembly;

FIG. 1B shows an end view of the aerator assembly;

FIG. 1C shows a section view of the aerator assembly when sectioned along plane A-A in FIG. 1B;

FIG. 1D shows a more detailed section view of the portion of the aerator assembly between the gas cylinder and the membrane when sectioned along plane A-A;

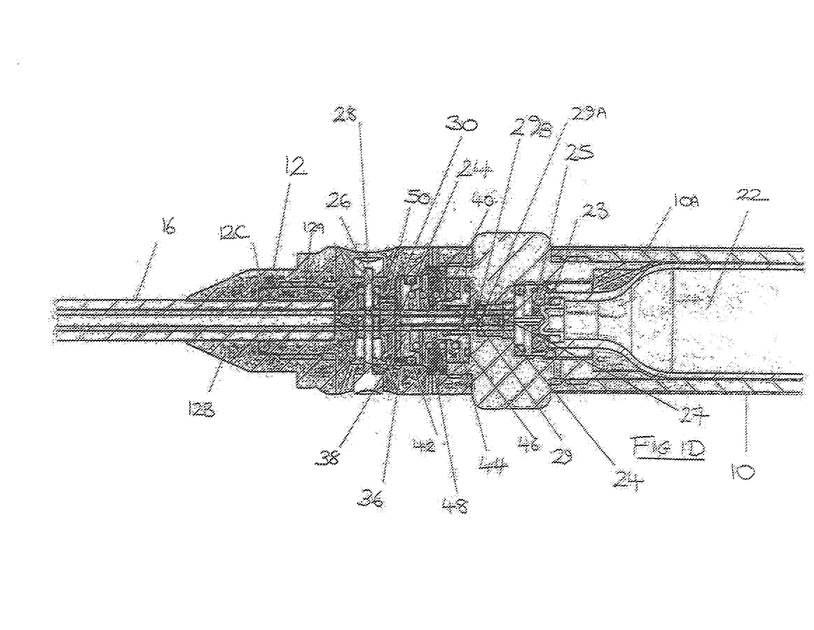

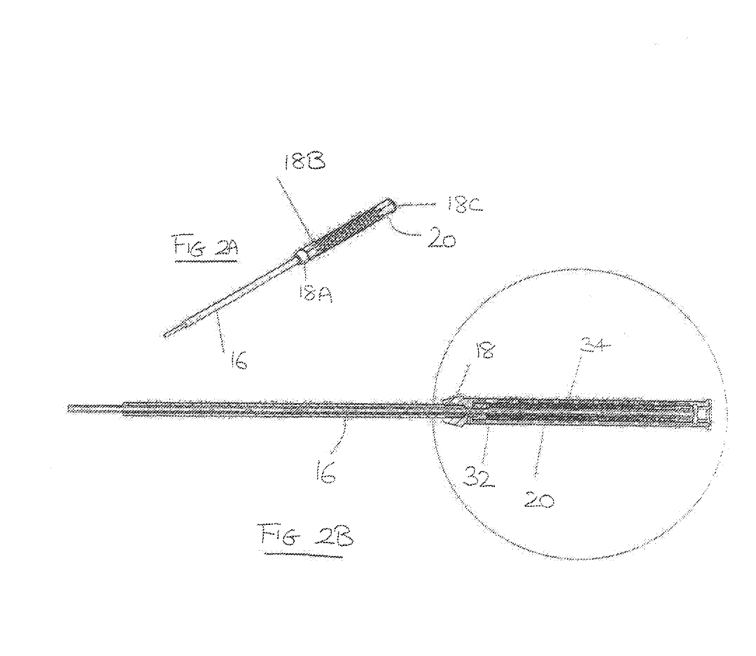

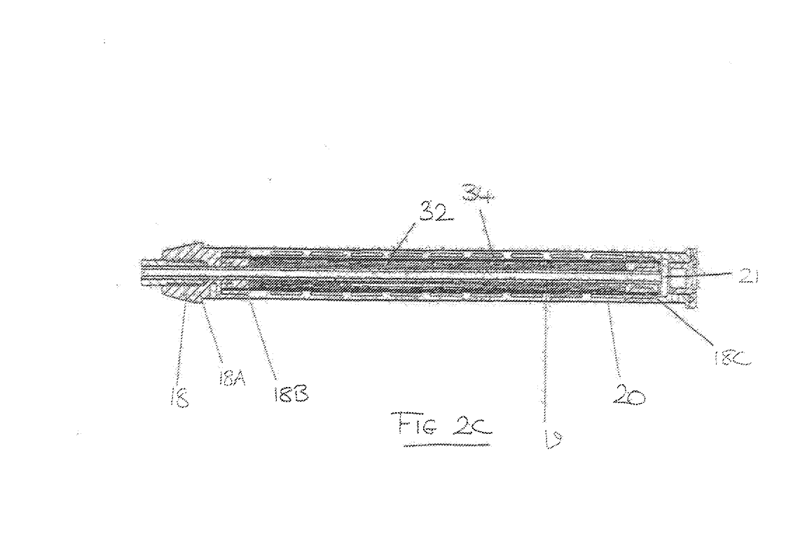

FIG. 2A shows a perspective view of the membrane and the tube covered by a protective sheath;

FIG. 2B shows a section view of the membrane and the tube covered by a protective sheath when sectioned along plane A-A;

FIG. 2C shows a more detailed section view of the membrane covered by a protective sheath when sectioned along plane A-A;

FIGS. 3A and 3B show both an exploded and non-exploded view of an alternative embodiment of the gas diffusion lance;

FIG. 4 shows an alternative embodiment of the aerator device;

FIG. 5 shows and alternative membrane fibre arrangement;

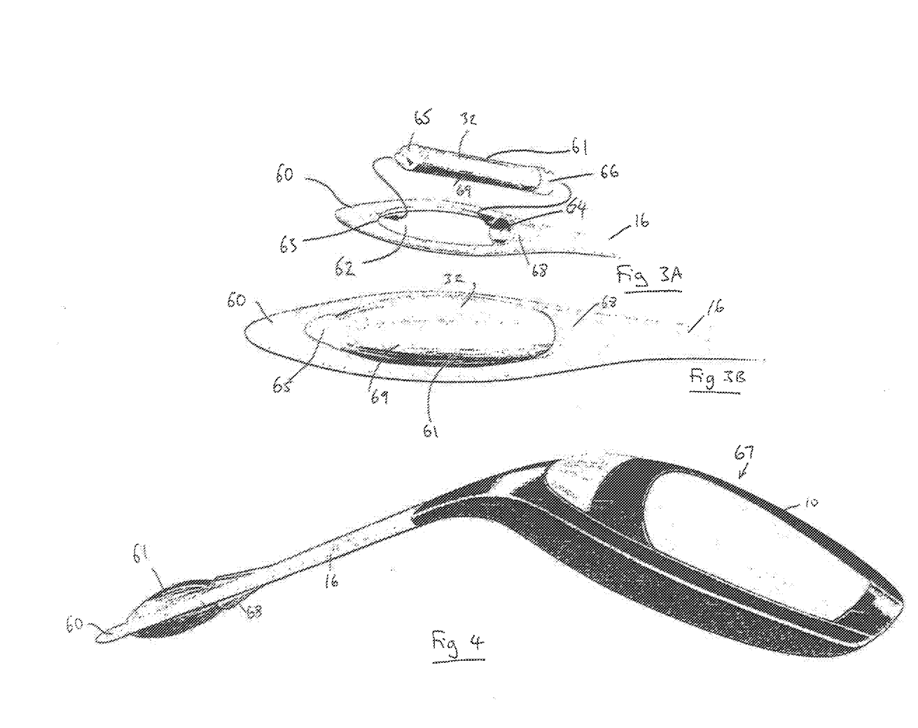

FIG. 6 shows a further alternative membrane fibre arrangement;

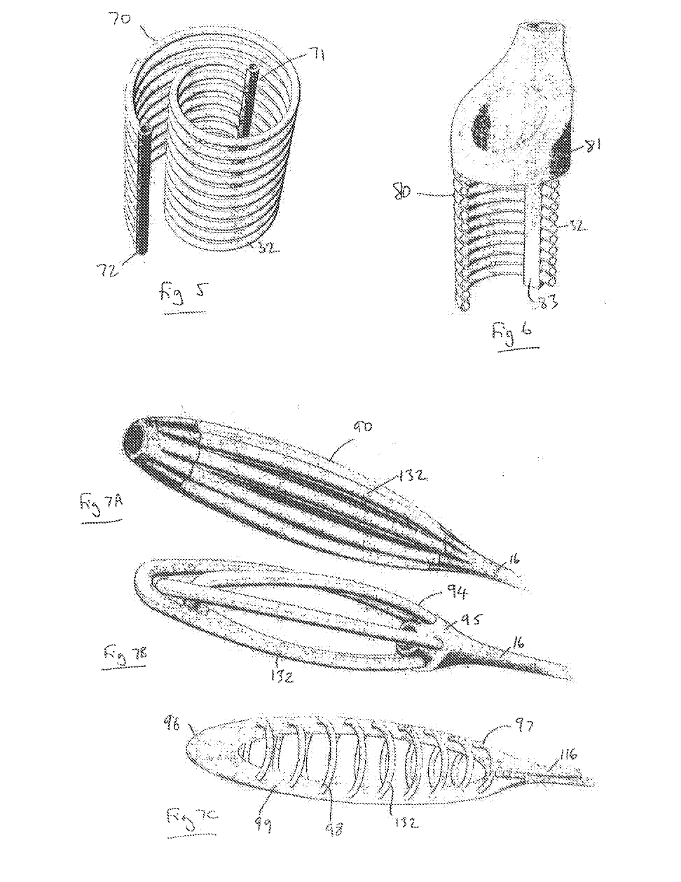

FIGS. 7A to 7C show still further alternative membrane arrangements;

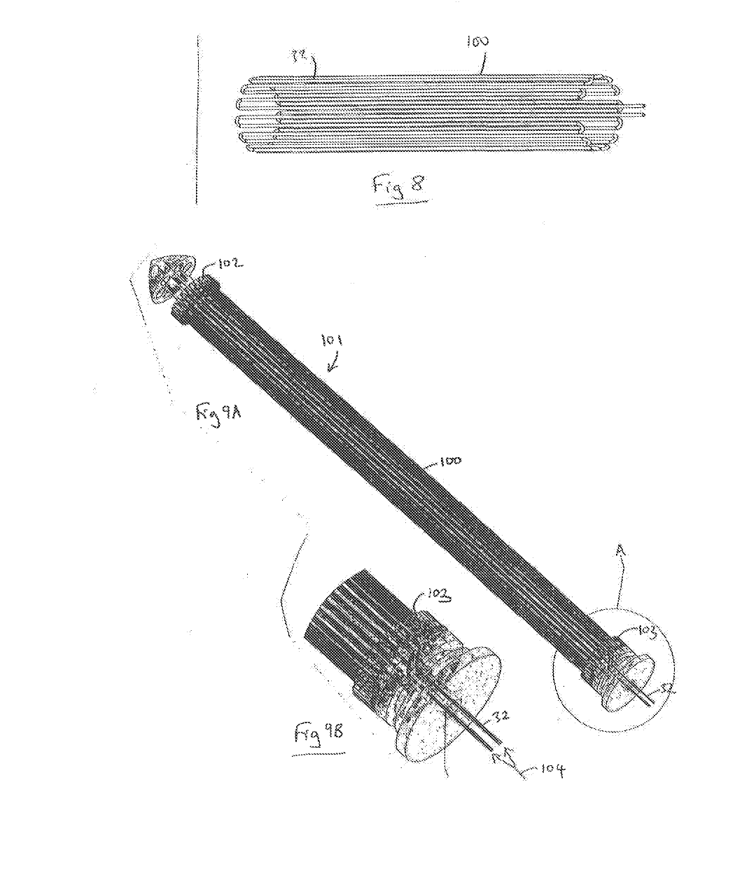

FIG. 8 shows an arrangement of a single fibre to form a membrane; and

FIGS. 9A and 9B show the membrane of FIG. 8 mounted on a gas diffusion lance.

Henceforth, the word ‘downstream’ means towards the membrane end of the gas path and the word ‘upstream’ means towards the cylinder end of the gas path.

The aerator assembly shown in the Figures is formed of three main parts: a body 10 for holding a gas cylinder 22, a diffusion lance 18 (see FIG. 2B), and a central tube 16 which connects the body 10 and the lance 18 together. In use, the aerator assembly is arranged to engage with the neck of a wine bottle which has a fluid content of 75 cl (not shown). The aerator assembly may be compatible however with larger bottles if desired, for instance a Magnum or a Jeroboam or any other bottle or container containing a liquid beverage to be aerated including other alcoholic and non-alcoholic beverages including, but not limited to, whiskey, gin, vodka and fortified wines.

The body 10 is sized so that it may be hand held by a user in one hand, and so that it completely encloses the gas cylinder 22. Consequently, the gas cylinder 22 is of a size and shape which fits within the body 10. A suitable gas cylinder 22 has a diameter of between 1 cm and 5 cm, and an overall length of between 5 cm and 15 cm.

As shown in FIG. 1D, an interface 12 connects the body 10 to the tube 16. The tube 16 may be permanently fixed to the body but is preferably removable. The interface 12 is formed of a first section 12A which forms part of the body 10 and a second section 12B which connects to and surrounds an upstream portion of the tube 16. The second section 12B connects to the first section 12A via a push in fitting. In their connected state, the two sections 12A; 12B of the interface 12 form a frustoconical shape which is dimensioned to partially fit inside the neck of the wine bottle to support the aeration device during use. The length of the tube 16 and diffusion lance 18 is preferably such that the downstream end of the diffusion lance 18 does not contact the bottom of the bottle in use.

To ensure a fluid seal between the two sections when they are connected, the first section 12A comprises a sealing o-ring 12C which engages with the second section 12B.

Although not shown, a number of optional resilient legs may be present which emanate from the interface 12 (or other part of the aerator device) and which are shaped to conform to the sloping surface defining the neck of the wine bottle, and which help ensure that the aerator assembly is correctly located over the wine bottle opening in use.

A pressurised gas cylinder 22 connects to the top of the body 10 by a screw thread (not shown) located on the body 10. The gas cylinder 22 can contain pressurised air, though preferably it contains pressurised gas containing more than 20% oxygen by volume, most preferably 100% oxygen, (when measured at atmospheric conditions) at a pressure between 20 bar (2 MPa) and 300 bar (30 MPa). However, the preferred cylinder gas pressure is 200 bar (20 MPa). As shown most clearly in FIG. 1D, the cylinder 22 comprises a crimped diaphragm 23, which is arranged to be perforated by a piercing tube 25 when the cylinder is connected thereto. A cover portion 10A of the body 10 surrounds the cylinder 22 in use.

Downstream from the gas cylinder 22 is a fluid channel 24 which extends through the body 10. The fluid channel 24 initially extends from the piercing tube 25 and passes through a filter block 27 in the body 10 for removing any impurities or particulates in the gas coming from the cylinder 22.

Downstream of the filter block 27, and inside the channel 24 of the body 10, is a valve 29 formed of an upstream valve seat 29A and a downstream valve head 29B which is engageable with the valve seat. The valve 29 is largely responsible tor throttling the pressure of the gas in the cylinder to a pressure of approximately 200 KPa-400 KPa which is suitable for use in the membrane as will be described.

Opening and closing of the valve 29 is controlled by a pressure regulation system 36 located inside a cavity 30 of the body 10 downstream of the valve 29.

The pressure regulation system 36 comprises, at its downstream end, a piston 38 which seals against the body 10 via an o-ring 42. The regulation system also comprises an elongate central piston rod 40 located inside the fluid channel 24 which engages with the piston 38. The upstream end of the piston rod 40 is engageable with the valve head 29B and contains a fluid channel (not shown) extending through its length to allow gas flow through the piston rod 40 as will be described.

At the upstream end of the regulation system a collar 44 located inside the cavity 30 abuts the body 10 and is sealed by an o-ring 46. A compression spring 48 extends between the piston 38 and the collar 44 to bias the piston 38 in the downstream direction.

In use, the downstream face of the piston 38 is acted upon by pressurised gas which passes through the central channel of the piston rod 40. When the pressure of the gas is high enough, the pressure overcomes the biasing force of the spring 48, thus moving the piston 38 and the piston rod 40 in the upstream direction. In so doing, the piston rod 40 moves the valve head 29B towards the valve seat 29A to restrict the gas passing through the valve and hence reduce the pressure. As the pressure on the downstream face of the piston 38 reduces, the spring 48 is able to once again bias the piston 38 in the downstream direction and the valve 29 is once again able to open.

Downstream of the pressure regulation system 36, a fluid channel 50, offset from the central axis of the body 10, forms a continuation of the fluid channel 24. The offset fluid channel 50 is selectively closable by a valve member 26, which is operated by a slidable switch 28 located on the outside surface of the body 10. In the position shown in FIG. 1D, the offset fluid channel 50 is blocked by the valve member 26.

Downstream of the valve 26 is the tube 16 which extends downwardly inside the wine bottle in use.

At the downstream end of the tube 16 is an aerator/diffusion lance 18 which comprises a protective sheath 20. In use, the diffusion lance 18 is at least partially immersed in the wine to be aerated as will be described. The diffusion lance 18 is in the region of 100 mm in length and 10-15 mm in width. The materials used in the diffusion lance 18 and the protective sheath 20 are preferentially hydrophilic so the wine can be easily rinsed from the components after use.

The diffusion lance 18 is best shown with reference to FIGS. 2A-2C. The lance 18 is generally cylindrical in shape and elongate in the direction of insertion which corresponds to the elongate axis of the surrounding wine bottle in use.

As shown in FIG. 2A-2C, the diffusion lance 18 comprises an upstream, central and downstream portion 18A; 18B; 18C. The tube 16 enters the diffusion lance 18 via its upstream portion 18A and forms a passage 19 which extends along the length of the diffusion lance 18. The downstream portion of the diffusion lance 18 comprises a manifold 21 which is fluidly connected with the passage 19. Connected to the manifold 21 are a number of individual hollow fibres 32 which extend axially along the length of the lance 18. The fibres 32 are bound together and sealed at the upstream portion 18A of the diffusion lance 18. Together, the hollow fibres surround the passage 19 and provide a membrane 31 with a large surface area for diffusing gas from the cylinder into the wine.

By having the manifold 21 located at the bottom portion of the diffusion lance 18, gas originating from the passage 19 which enters the manifold necessarily incurs a reversal in direction as it travels up into each of the hollow fibres 32.

The diffusion lance 18 shown in FIGS. 2A-2C contains between forty and fifty individual fibres 32, although more or less than this amount of fibres could be used. Oxyplus™ capillary membrane hollow fibres, which each have an external diameter of 380 microns and an internal bore of 260 microns, are an example of a suitable fibre for use in the membrane 31 of the diffusion lance 18. These fibres are also particularly effective at producing bubbles with a small mean size. The fibres are supplied by Membrana GmbH and contain polymethylpentene.

A protective sheath 20 surrounds the membrane fibres 32 as shown in FIGS. 2A-2C. The protective sheath 20 is preferably made of stainless steel (to prevent chemical interaction with the wine to be aerated) and comprises a number of openings 34 which allow wine to pass therethrough and into contact with the hollow fibres 32 of the membrane 31.

Operation of the aerator assembly is best shown with reference to FIGS. 1A and 1D. Initially, a gas cylinder 22 is connected to the body 10, whilst ensuring that the valve 26 is in its closed position.

When the gas cylinder 22 is initially connected with the body 10, the piercing tube 25 pierces the crimped diaphragm 23 of the gas cylinder 22 to allow high pressure gas to pass from the cylinder into the channel 24 past the filter block 27 and the valve 29. In passing between the cylinder and the valve 29, the gas is throttled from the pressure inside the gas cylinder down to a lower pressure of between 100 KPa-400 KPa. The lower pressure gas then passes through the fluid channel inside the piston rod 40 and out from its downstream end. The lower pressure gas enters the offset fluid channel 50. When the valve 26 is toggled open, the gas from the offset channel 50 then passes the valve 26 info the tube 16 as will be described. When enough gas has passed through the assembly to achieve the desired level of aeration, the valve 26 is toggled closed (as shown in FIG. 1D) to block the offset channel 50, preventing further gas from reaching the tube 16.

When gas enters the tube 16, it subsequently passes into the passage 19 inside the diffusion lance 18 and then into the manifold 21 located at the downstream end of the lance 18.

Inside the manifold 21, the direction of the gas flow is substantially reversed as the gas enters each of the hollow fibres 32. This change of direction can be used as a mechanism to further throttle the pressure of the gas before it enters the hollow fibres 32.

When entering each of the hollow fibres 32 from the manifold 21, the oxygen containing gas is above atmospheric pressure. The wine itself is at atmospheric pressure. As a result, a pressure gradient is formed between the interior and exterior surfaces of each hollow fibre 32 which causes the pressurised gas to diffuse through the hollow fibres 32 to react with the wine. Because of the large number of hollow fibres 32 used, the membrane 31 has a relatively high surface area to volume ratio, which means that it can achieve a fast diffusion rate of gas therethrough. The gas which diffuses through the fibres 32 forms bubbles with a small mean bubble size. As a result of these small bubbles, the gas may quickly diffuse and react with the wine.

It will be appreciated that the hollow fibres 32 are made from a material, or a combination of materials, which is suitable for diffusing oxygen therethrough and which is capable of generating bubbles with a small mean size. Possible example materials includes, but are not limited to, polyethylene; polydimethyl siloxane (PDMS); polyolefin; silicone-coated polypropylene (Si-PP); polyimide/polyethersulfone; silicone; and polyether ether ketone (PEEK).

If the pores of the membrane 31 break down and allow too much gas flow therethrough, the lance 18 can be replaced and the new lance 18 fitted to the remaining parts of the device. Alternatively, only the membrane 31 may be replaced inside the lance 18.

Using the arrangement described above, it is possible to aerate a standard 75 cl bottle of wine with 3-10 mg O₂/l wine, when measured at atmospheric conditions, in less than 2 minutes.

Referring to FIG. 4, an alternative embodiment of an aeration device 67 is shown. To avoid duplication, like features of the aeration device 67 are referenced with the same reference numerals to those used above. Therefore, the aeration device 67 comprises a body 10 housing a gas cylinder (not shown) and a tube 16 connecting the body 10 to the gas diffusion lance 60. In this embodiment, the gas diffusion lance 60 is integral with the tube 16. In use, gas passes from the body 10 through tube 16 to a manifold portion 68 of the lance 60. In this embodiment, the main longitudinal axis of the tube 16 is not co-axial with that of the body 10.

As shown in FIGS. 3A to 3B, the lance 60 comprises an opening 62 which is arranged to receive a membrane cartridge 61. The membrane cartridge 61 comprises an upstream manifold 66 and a downstream manifold 65. The upstream and downstream manifolds are connected by a resiliently deformable member (not shown) and a plurality of fibres 32 extend from the upstream manifold 66 to the downstream manifold 65 to form a gas delivery membrane 69. In contrast to the arrangement described above with reference to FIGS. 2A and 2B, in this embodiment the open end of the fibres 32 are located in the upstream manifold 66 to receive gas supply from the tube 16. The downstream ends of the fibres 32 are sealed off in downstream mandrel 65.

The upstream manifold 66 of the membrane cartridge 61 is configured to fit in fluid tight engagement within the manifold 68 of the lance 60 so that gas can be delivered to the fibres 32 in use. The downstream manifold 65 of the membrane cartridge 61 has a cut out 69 which is shaped to engage with the downstream side of the cut out 62 in the lance 60.

The overall length of the membrane cartridge 61 is greater than the overall length of the opening 62 in the lance 60. Therefore, when the membrane cartridge 61 is received within the opening 62, the fibres 32 balloon outwardly of the opening 62. The membrane cartridge 61 is retained in place within the opening 62 by means of the resiliently deformable member connecting the upstream and downstream mandrels 66, 65. It will be noticed that in this embodiment the gas diffusion lance 60 does not have a protective sheath. Of course, a protective sheath may be used if desired.

FIG. 5 shows an alternative arrangement of fibres 32 forming a membrane 70. As shown, a plurality of fibres 32 emanate from a central manifold 71 to a radially spaced manifold 72 in substantially a spiral formation. In this embodiment, gas flows from the central manifold 71 to the radially spaced manifold 72. This arrangement may be reversed if desired.

FIG. 6 shows a still further alternative arrangement of fibres 32 forming a membrane 80. As shown, a single fibre 32 emanates from an upstream manifold 81 to a downstream manifold (not shown) in a substantially helical formation. In this embodiment, gas flows from the upstream manifold 81 to the downstream manifold. This arrangement may be reversed if desired. The fibres 32 of the membrane 80 are supported by a support member 83. However, it is envisaged that the support member 83 will not be necessary in all embodiments with all material types and that the membrane 80 may be self supporting.

FIGS. 7A to 7C show further alternative membrane arrangements. In the embodiment of FIG. 7A, a membrane 90 is formed by a plurality of fibres 132 in much the same way as described above with reference to FIG. 3A. However, in this embodiment the fibres 132 are of greater diameter than the fibres 32 of FIG. 3A. In this embodiment, a particularly suitable material for forming the fibres 132 is an ultra-thin silicone material having a wall thickness of 0.07 mm and an internal diameter of 0.4 mm such as may be obtained from RAUMEDIC AG, Hermann-Staudinger-Str. 2, D-95233, Helmbrechts, GERMANY. Such material has particular benefit in that it has a clean surface and is not porous allowing for less contamination potential and easier cleaning. With this material the gas is able to diffuse from the inside of the fibre to the outside of the fibre directly through the silicone wall material. It will be understood that this material may be used for any of the fibre arrangements described herein.

FIG. 7B shows an alternative arrangement of the fibres 132 configured to form a membrane 94. In this embodiment the fibres 132 form an egg-whisk type arrangement with the fibres 132 stating and ending at an upstream mandrel 95 which is integral with the tube 16. It will be understood that an egg-whisk type arrangement in which the fibres start and finish at a common mandrel is equally suitable for fibres having smaller internal diameters such as the fibres 32 described above.

FIG. 7C shows a still further alternative arrangement of the fibres 132 configured to form a membrane 97. In this embodiment the fibres 132 form axially spaced rings 98 which receive gas from an elongate ellipsoid shaped mandrel 99 which also forms the diffusion lance 96. The mandrel 99 is integral with the tube 116.

A final exemplary embodiment of a membrane 100 is shown in FIG. 8. The membrane 100 comprises a single fibre 32 wound onto two bobbins 102, 103 (FIGS. 9A and 9B) which are respectively supported on the downstream and upstream ends of a gas lance 101. In use, gas enters the fibre 32 via both ends as indicated by arrows 104. Alternatively, the gas may enter the fibre 32 via one of its ends only.

### EXAMPLE

In an exemplary arrangement, an aerator device was used comprising 50 Oxyplus™ capillary membrane hollow fibres, each with an external diameter of 380 microns, an internal bore of 260 microns, and a length of 100 mm. A gas cylinder containing pressurised gas of 100% oxygen by volume at a pressure of 150,000 to 200,000 kPa was connected to the device.

The device was inserted into a standard wine bottle containing 75 cl of Blaufränkisch 2009 and the switch 28 on the body 12 of the device moved to its open position to allow gas to diffuse through the membrane. The device then aerated the wine for 1.5 minutes at a gas flow rate of 0.23 l/min (measured at standard atmospheric conditions), in which time the oxygen content of the wine increased from 1.14 mg O₂/l wine to 6.01 mg O₂/l wine.

In a separate experiment the device was inserted into a standard wine bottle contacting 75 cl of Graciano, 2010. The device then aerated the wine for 1.5 minutes at a gas flow rate of 0.23 l/min (measured at standard atmospheric conditions), in which time the oxygen content of the wine increased from 0.87 mg O₂/l wine to 3.98 mg O₂/ wine.

1. A wine aerating device for adding oxygen gas into wine in a wine bottle, the device comprising a body for receiving a pressurised gas cylinder containing at least 20% oxygen by volume when measured at atmospheric conditions, a tube with a first end connected to the body and a second end connected to a membrane, the membrane comprising a plurality of hollow fibres and being insertable through the neck of the wine bottle so that, in use, oxygen gas diffuses via the membrane into the wine.

2. The device according to claim 1 wherein the tube passes from the body beyond the membrane to a manifold from which the membrane extends back towards the body.

3. The device according to claim 1 wherein the membrane is elongate in the direction of insertion.

4. The device according to claim 1 further comprising a pressure limiting valve for lowering the pressure of the gas from the cylinder, in use, to a predetermined pressure before the gas reaches the membrane.

5. The device according to claim 4 wherein the valve comprises a valve seat and a valve head, wherein the predetermined pressure is maintained by a spring means which controls the separation between the valve seat and the valve head.

6. A device according to claim 1 suitable for use with a cylinder having an internal pressure when full of between 2 MPa and 30 MPa.

7. The device according claim 1 wherein, in use, when gas flows from the cylinder, the pressure of the gas at the membrane is less than 50% of the pressure inside the cylinder.

8. The device according to claim 7 wherein the pressure of the gas at the membrane is less than 25% of the pressure inside the cylinder.

9. The device according to claim 8 wherein the pressure of the gas at the membrane is less than 10% of the pressure inside the cylinder.

10. The device according to claim 1 wherein, in use, the pressure in the cylinder and the size of the tube and membrane are such that the device can supply 3-10 mg O₂/l wine, measured at atmospheric conditions, to 75 cl of wine in less than 2 minutes.

11. The device according to claim 1 further comprising a protective sheath, surrounding the membrane, and containing outlets which allow gas to pass therethrough.

12. The device according to claim 1 wherein the membrane is either a dense membrane or a microporous membrane.

13. The device according to claim 1 wherein the membrane is made of a polymeric material.

14. The device according to claim 1 wherein a portion of the membrane is made from a hydrophilic material.

15. The device according to claim 1 further comprising a mount for mounting the device on the neck of the wine bottle.

16. The device according to claim 15 wherein the mount comprises a bung which is dimensioned to fit in the neck of the wine bottle.

17. The device according to claim 1 further comprising a piercing element for piercing a seal on the cylinder.

18. The device according to claim 1 wherein the body, the tube, and the membrane are co-axial.

19. The device according to claim 1 wherein the width of the membrane is less than 18 mm.

20. A method of adding oxygen containing gas to a volume of wine of 75 cl, the method comprising passing between 3-10 mg O₂/l wine, measured at atmospheric conditions, from a compressed gas cylinder through a membrane into the wine in less than 2 minutes.

21. A method according to claim 20 wherein the pressure inside the gas cylinder, when full, is between 2 MPa and 30 MPa.

22. A method according to claim 20 wherein, when gas flows from the gas cylinder, the pressure of the gas at the membrane is less than 50% of the pressure inside the gas cylinder.

23. A method according to claim 22 wherein the pressure of the gas at the membrane is less than 25% of the pressure inside the gas cylinder.

24. A method according to claim 23 wherein the pressure of the gas at the membrane is less than 10% of the pressure inside the gas cylinder.

25. A method according to claim 20 wherein the wine is contained in a wine bottle and the method includes the step of inserting the membrane through the neck of the wine bottle.

26. A kit comprising
a device for adding oxygen gas into wine in a wine bottle, the device comprising a body for receiving a pressurised gas cylinder containing at least 20% oxygen by volume when measured at atmospheric conditions, a tube with a first end connected to the body and a second end connected to a membrane, the membrane comprising a plurality of hollow fibres and being insertable through the neck of the wine bottle so that, in use, oxygen gas diffuses via the membrane into the wine, and
a compressed gas cylinder containing at least 20% oxygen by volume when measured at atmospheric conditions.
